(19) United States
(12) Patent Application Publication
(10) Pub. No.: US 2003/0182093 A1
(43) Pub. Date: Sep. 25, 2003

(54) Controlling azimuthally varying continuity in geologic models

(76) Inventors: Thomas A. Jones, Bellaire, TX (US); J. Lincoln Foreman, Houston, TX (US); Tingting Yao, Pearland, TX (US)

Correspondence Address: Stephen P. Koch, ExxonMobil Upstream Research Company, P.O. Box 2189, Houston, TX, 77252-2189, US

(21) Appl. No.: 10/105,664

(22) Filed: Mar. 25, 2002

(51) Int. Cl. G06G 7/48

(52) U.S. Cl. 703/11

(57) ABSTRACT

This invention is a method of generating a continuity-controlled geologic model of a feature within a subsurface volume of the earth. The method involves the specification of both a reference line corresponding to the feature, and a coordinate transformation for which the reference line is made linear in a transformed coordinate system. Geologic modeling of the linearized feature in the transformed coordinate system allows the continuity of the feature to be controlled, and an inverse transform allows the model to be presented in the original coordinate system.

### FIELD OF THE INVENTION

This invention relates to the field of three-dimensional geologic modeling. More specifically, this invention relates to a method of generating geologic models in which lithological and petrophysical properties may be modeled with orientations of continuity that are consistent with depositional features.

### BACKGROUND OF THE INVENTION

A geologic model is a three-dimensional, computer-based representation of a region of the subsurface of the earth, such as a petroleum reservoir or a depositional basin. Geologic models may take on many different forms. Most commonly, geologic models built for petroleum applications are in the form of a three-dimensional array of blocks (also referred to as cells) or less commonly points. Hereafter, geologic models will be referred to as being comprised of blocks. The entire set of blocks constitutes the geologic model and represents the subsurface volume of interest to the modeler. Each block represents a unique portion of the subsurface, and blocks do not intersect each other. Dimensions of the blocks are generally chosen so that rock properties are relatively homogeneous within a block, yet without creating a model with an excessive number of blocks. Most commonly, blocks are square or rectangular in plan view, with a thickness that is either constant or variable, but any shape may be used.

The geologic-modeling process assigns values of rock properties of interest to all blocks within the geologic model, a process that is known to practitioners of geologic modeling. Examples of properties that may be of interest to a modeler include facies, lithology, acoustic impedance, porosity, permeability, and water saturation. The geologic, geophysical, or engineering data and interpretations that are integrated into the blocks of the geologic model can come from many different sources, including cores, wireline logs, outcrop analogues, and 2-D or 3-D seismic data.

The values of the rock property that are to be assigned to the blocks are calculated using one of many methods that are known in the art. Most commonly, object-based or geostatistical methods, or a combination of both, are used. Object-based methods are used to model facies or lithology, whereas geostatistical methods are more commonly used to model lithological or petrophysical properties, perhaps using facies or lithology as a template. This invention is concerned with modeling these lithological or petrophysical properties.

Geostatistical methods take spatial continuity of the rock property into account as a function of direction and distance between individual blocks in the model, between observed data locations, and between observed data locations and blocks. The methods characterize the three-dimensional continuity of a rock property using a variogram or covariogram model. Both deterministic and stochastic geostatistical methods are used in geologic modeling. Deterministic geostatistical methods, such as kriging, are averaging methods that use the variogram model to assign weights to the neighboring data as a function of distance and direction from the estimation block. Kriging estimates are limited, however, because heterogeneity in the rock property is not reproduced. Stochastic geostatistical methods, such as sequential-Gaussian simulation and sequential-indicator simulation, are used instead to generate geologic models that honor desired spatial heterogeneity.

At present, however, geostatistical methods are limited to generating models that honor spatial heterogeneity along a single direction of continuity. These methods do not generally allow the direction of continuity to vary spatially, a limitation on the extent to which the resulting model can accurately characterize the subsurface volume of interest to the modeler. For example, it is well known that the continuity of porosity within a subsurface volume is typically highest along the axis of channels that may be present in the subsurface, and lowest perpendicular to the axis of any such channels. However, most modeling methods do not allow the direction of continuity to vary spatially along channels, but instead impose a single direction of strongest continuity within the model.

More specifically, a group of one or more channels may extend generally from west-to-east in a model, while strong sinuosity at the same time may cause many of the channel reaches to deviate from that west-to-east direction. In such a case, typical modeling techniques will generate models in which porosity is mapped in a manner which shows streaks of high and low values that are aligned in a west-to-east direction. An example of this result is depicted in FIG. 1, which shows a map of porosity in a single channel within a river system feature that was generated in a model having a constant west-to-east orientation of continuity. Porosity continuity, which is generally indicated by contiguous cells having similar shading, is only present in a west-to-east orientation, in other words from left-to-right in the figure. This west-to-east orientation of contiguous cells does not correlate well with the local orientation of the channel. A method that provides an ability to generate models that honor the local orientation of the channel is desired.

The desire for such methods is not limited to single channel characterization, however. Complexes of channels and other depositional forms and bodies are perhaps of greater interest than are individual channels. For example, complexes of sandstone-filled fluvial channels may show up against a background of shaley overbank deposits. More broadly, several environments of deposition may be interpreted in the subsurface as illuminated by the seismic survey, or seismic attributes may be found to delineate portions of the subsurface in the form of seismic facies. Such seismic data may provide information on how lithologic and petrophysical properties should be oriented in the subsurface and hence in the model. However, the limited extent to which such good data sources are available make this capability of limited general benefit to geologic modelers. In addition, even such good data sources are generally insufficient to meet the objectives of geologic modelers. Specifically, such modelers may be able to observe patterns in the seismic data, but the level of detail inherent to the underlying data source is inadequate to allow those patterns to be accurately incorporated into geologic models. Furthermore, geostatistical methods do not generally include a mechanism by which the information from these different types of data sources can be reflected in a geologic model. For all these reasons, existing methods can often result in unrealistic distributions of lithology and porosity within channels or other bodies.

Another petrophysical-modeling approach is referred to as spectral-component geologic modeling. Although many of the limitations of geostatistical methods also apply to spectral-component geologic modeling, this approach does provide the modeler with greater flexibility to control the effect that uncertainty in data, interpretations, and assumptions have on the geologic model. More specifically, it is understood in the art that the spatial heterogeneity of rock properties within a petroleum reservoir can be described over a wide range of spatial scales. Each data source that is integrated into the geologic model represents a specific scale of information, for example, well data generally provide finer-scale information than do seismic data. The proper integration of the different data types into the geologic model should account for the scale of information represented by each type. Because frequency is a representation of scale, it is useful to consider the frequency content of the input data when building the geologic model. Short-range or fine-scale variability in the reservoir corresponds to high-frequency heterogeneity, whereas long-range or coarse-scale variability corresponds to low-frequency heterogeneity. The spectral-component approach to geologic modeling, which relies for example on the Fourier transform, allows variabilities of scale to be reflected in the geologic model. This is an improvement over other geologic-modeling methods, which do not properly account for the frequency content of the different data types used to construct the model.

Because different data sources may represent different frequency ranges in spatial variability, Fourier transform methods allow individual spatial components to be independently modeled. More specifically, the Fourier transform converts a stationary covariance from the space domain into an amplitude spectrum in the frequency domain. As described by Calvert et al. in U.S. patent application Ser. No. 09/934,320 “Method of Constructing 3-D Geologic Models by Combining Multiple Frequency Passbands,” different data sources will generate amplitude spectra encompassing specific, and generally independent, frequency ranges, and taken together a composite spectrum can be generated. The inverse Fourier transform of this composite spectrum directly yields a version of the integrated result in the space domain (in other words, a realization of a geologic model of the subsurface volume of interest).

Although spectral-component geologic modeling allows variations deriving from the different nature of the data sources to be reflected in the geologic model, this approach also suffers from the limitation that variations in the direction of continuity, which relate for example to channel sinuosity, cannot be incorporated into the model. Without a capability of modeling the correct azimuthal orientation of continuity in a model, the benefits of generating a model with accurate spectral characteristics are limited. As a result, a method is desired that allows the generation of geologic models in which lithological or petrophysical properties may be modeled with consistent, varying, and pre-specified, orientations of continuity of the property. Any such continuity-controlled geologic modeling method should preferably result in a more accurate model of the heterogeneity of the subsurface volume of interest, but at a negligible cost in either analytic effort or time. The method should preferably involve user-specified, varying orientations of continuity to be taken into account, while generating a model with the benefits of spectral simulation. The present invention addresses this desire.

### SUMMARY OF THE INVENTION

The present invention is a method of generating a continuity-controlled geologic model of a subsurface volume of the earth. The method involves the specification of a coordinate system defining the subsurface volume, and a feature within the volume, for which a geologic model is desired. A curved reference line corresponding to the feature is specified, and a transformation to a second coordinate system is determined such that the reference line is straight in the second coordinate system. The data used for modeling, which correspond to the feature and to the geologic model to be generated, are also transformed into the second coordinate system. Geologic modeling of the feature in the second coordinate system allows the continuity of the feature to be controlled with a constant orientation. An inverse transform from the second coordinate system back to the first coordinate system results in a continuity-controlled geologic model.

### BRIEF DESCRIPTION OF THE DRAWINGS

The features of the present invention will become more apparent from the following description in which reference is made to the drawings appended hereto.

FIG. 1 depicts a plan view of a channel feature in which a constant orientation of continuity was assumed in the geologic model

FIG. 2 depicts a three-dimensional representation of subsurface volume of the earth having three features for which continuity-controlled geologic modeling is desired.

FIG. 3 depicts a flow chart of a first embodiment of the present method.

FIG. 4 depicts a flow chart of a second embodiment of the present method.

FIG. 5A depicts a plan view of a thalweg corresponding to a feature within a subsurface volume of the earth and a first measurement approach which may be used to determine a transform of the thalweg into a second coordinate system. FIG. 5B depicts a plan view of the thalweg of FIG. 5A after transformation into a second coordinate system.

FIG. 6A depicts a plan view of three thalwegs corresponding to features within a subsurface volume of the earth. FIG. 6B depicts a plan view of the thalwegs of FIG. 6A after transformation into a second coordinate system.

FIG. 7 depicts a plan view of a channel feature resulting from an azimuthal continuity-controlled geologic model deriving from an embodiment of the present invention.

Changes and modifications in the specifically described embodiments can be carried out without departing from the scope of the invention, which is intended to be limited only by the scope of the appended claims.

### DETAILED DESCRIPTION

The present invention is a process of building geologic models of the subsurface of the earth. The process is primarily directed at representations of petroleum reservoirs and/or aquifers, but may also be used for other applications. The process produces geologic models that allow the orientations of direction of strongest continuity in the property being modeled to vary throughout the model. The method uses characteristics of both the variable-azimuth process and spectral-simulation modeling to generate models that more accurately characterize complex subsurface features.

More specifically, this invention allows the modeler to build continuity-controlled geologic models in which the direction of strongest continuity bends spatially according to geologic or geophysical interpretations of the underlying data sources. These interpretations result in a path of strongest continuity for each of one or more channels or other geologic features; the path for each of these features is defined by what this invention calls a thalweg. The term thalweg derives from the hydrologic art, and is used herein to represent a reference line through any seismic facies, complex, or other feature of interest. That reference line will most commonly be a centerline through the feature. A thalweg will generally be represented by a set of connected line segments that defines a curved line through the subsurface volume, and in that way will be used to indicate a spatially varying azimuth of continuity of the property of interest.

In the present invention the thalweg is used to alter the coordinate system used in the modeling process. This alteration is carried out in such a manner that the direction of strongest continuity is made to have a constant orientation in the altered coordinate system, thereby allowing a model to be built using existing unidirectional modeling algorithms. Thereafter, restoring the model to the original coordinate system results in a model in which the azimuth of continuity follows the path of the thalweg, and the spatial continuity of the feature that is associated with the thalweg is preserved.

For computational efficiency, the process is generally applied only to that portion of the 3-D model for which continuity is intended to be azimuthally controlled for the feature of interest. The features of interest may include, without limitation, channel complexes, environments of deposition, seismic facies, or other geologic structures. Occasionally, that feature will affect an entire 3-D model. In some models, two or more features, may be interpreted in which the petrophysical property corresponding to each feature has a varying azimuth within a limited region of the model. In such cases, the process may be applied to each such feature of the model, each with a separate thalweg. The results of these multiple applications of the present method may then be used to derive a single model having azimuthal controlled continuity for each such feature.

The process allows the modeling of one or more rock properties. In addition, the statistics, for example, variograms, spectra, or histograms, and controls chosen to describe the characteristics of the tentative geologic models are not restricted and may be in any convenient form that specifies the desired properties.

The process may be applied to the modeling of such geologic properties as porosity, shale volume (also referred to as Vshale), and net-gross ratio (more generally referred to as lithology fraction). Other properties for which the process may be applied will be known to those skilled in the art. For convenience, references herein will frequently be to porosity, but such references are not intended to be limiting.

The description of the process refers to the blocks in a geologic model. However, the process may be practiced for other configurations, and such references are not intended to be limiting. For instance, rather than using blocks that define volumes, we may use an array of sample points within a 3-D volume. Properties in the model would be assigned to all points in the array.

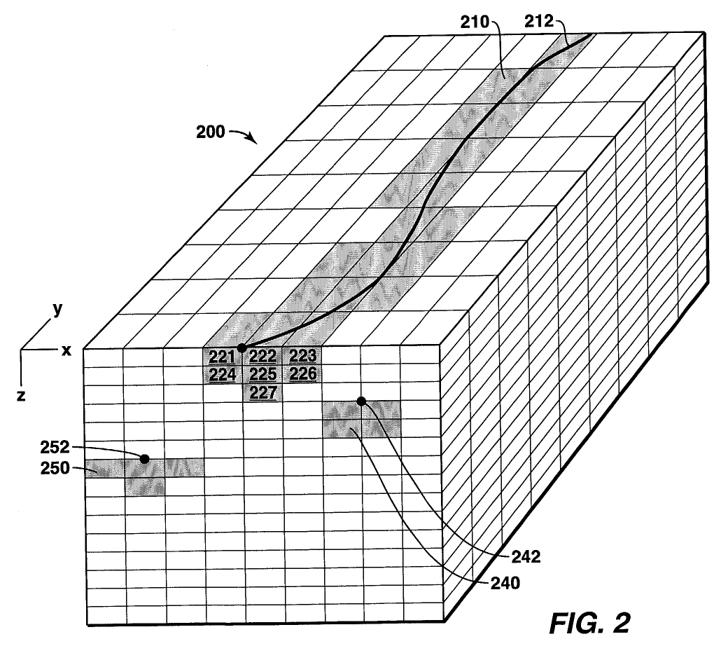

The present method may be more clearly described with reference to subsurface volume 200 in FIG. 2. Subsurface volume 200 is comprised of a two-dimensional or three-dimensional array of blocks defined in reference to an XYZ coordinate system, also referred to herein as XYZ space. The volume may be two-dimensional when the feature of interest has boundaries which are generally invariant with depth, and/or when there are no vertical correlations or continuity variations that need to be modeled. Generally, however, the volume will be three-dimensional. Note that the XYZ origin depicted in FIG. 2 is for simplicity and is not limiting. A first feature 210 is depicted for which azimuthally controlled continuity modeling is desired. Thalweg 212 corresponds to feature 210, and is depicted as lying on the uppermost surface of feature 210. It will be noted in FIG. 2 that feature 210 meanders over a range of X and Y values, and extends downward in the Z direction. The lateral and vertical extent of feature 210 is indicated by the shaded blocks centered on and lying below thalweg 212. It will be understood that thalweg 212 represents a centerline through feature 210, and the nature of petrophysical features is such that the centerline of a feature generally does not vary laterally with depth. For example, the centerline in the uppermost layer of feature 210, which comprises blocks 221, 222, and 223 at the coordinate Y=0 of FIG. 2, will lie vertically above the centerline of feature 210 at the second layer, which comprises blocks 224, 225, and 226 at coordinate Y=0. This characteristic continues over the range of Y coordinates that encompass the feature. Therefore, the specification of a thalweg in a first, uppermost, layer of a feature will, in general, also specify the characteristics of the centerline of the feature at increasing depths in the model. Reference hereafter will therefore be made to a thalweg as lying on the uppermost surface of a feature. Such references, and this characteristic of the centerline of features, are not a limitation of the present method, however, but allow computational efficiencies, which are described further below.

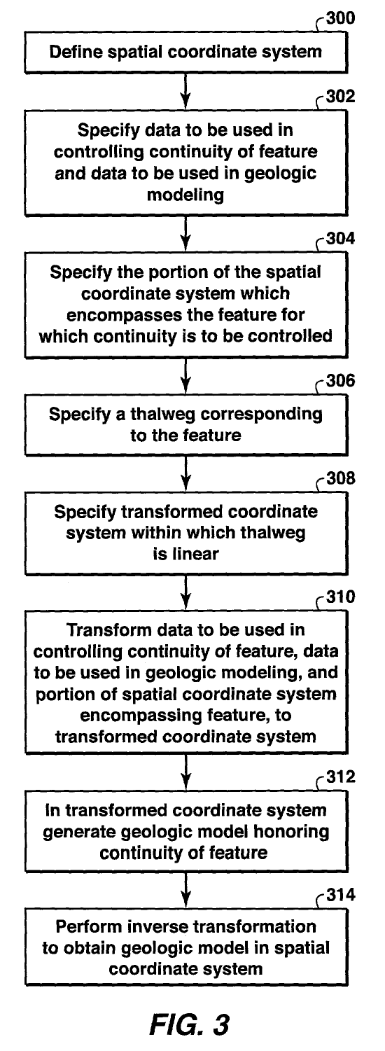

As will be understood to those skilled in the art, to the extent that subsurface volume 200 contains a feature 210 for which continuity is intended to be modeled, feature 210 will not generally be present in volume 200 at a constant depth below the surface of the earth (not depicted in FIG. 2). For this reason, and for computational convenience in the modeling of any such feature, the Z coordinate for a volume 200 of such model will not generally represent a fixed absolute depth below the surface of the earth, but instead will be defined in such a manner that the feature of interest, such as feature 210 in FIG. 2, remains at a constant Z coordinate within volume 200. In other words, blocks in the uppermost layer of a feature may have identical Z coordinates in the XYZ space of the subsurface model, but may not all lie at a constant depth below the actual surface of the earth. The Z coordinate is thus defined to be relative to one or more geologic surfaces, such as stratigraphic or structural surfaces. For instance, Z may be defined to be the depth below the top of a stratigraphic zone. References to any such relative coordinate system are often referred to relative Z, or Z_{REL}, space. Using this relative Z coordinate system allows the feature of interest to be analyzed within the model in a manner that is consistent with its deposition in the subsurface of the earth. This manner of defining the Z coordinate for the subsurface volume of interest, such as volume 200 in FIG. 2, simplifies the application of the method of the present invention to the azimuthal continuity modeling of the feature of interest, and will be understood to those skilled in the art. Specifically, this manner of defining the relative Z coordinate for a feature such as feature 210 of volume 200 in FIG. 2 allows for the transformation to the transformed coordinate system to be applied sequentially in two-dimensional calculations for individual layers (individual portions of the subsurface having a fixed relative Z value), rather than in a three-dimensional calculation. For example, a first transformation corresponding to feature 210 of volume 200 could be applied to the blocks of the feature having a first Z value, such as blocks 221, 222, and 223, and the blocks extending in increasing values of Y through volume 200 at that constant Z value. Next, a transformation could be applied to the blocks having a second Z value, such as blocks 224, 225, and 226, and the other blocks corresponding to that depth, and finally to a third Z value, such as block 227 and its corresponding blocks. In this manner the continuity of the entire feature 210 can be modeled according to the method of the present invention, but the coordinate system transformation calculations do not require three-dimensional arrays or three-dimensional calculations. Note that this approach is not a limitation of the present method, but rather is a convenience that may be employed to facilitate the modeling that will be performed as part of the present method, as further discussed below in conjunction with FIG. 3. However, it should also be noted that once all layers for a feature of interest have been transformed to a transformed coordinate system, the modeling of the feature will generally be carried out in three-dimensional calculations, to thereby facilitate calculation of correct vertical correlations and continuity. It will be understood to those skilled in the art that references to Z are to the Z coordinate as defined for a specific analysis, which may be either absolute or relative Z, and that the method of the present invention is not limited solely to either of these coordinate system definitions. It will also be understood to those skilled in the art that the Z coordinate may be defined either in depth (units of meters subsurface for example) or in seismic time (units in seconds), and that the method of the present invention is not limited to either coordinate definition.

In FIG. 2, a second feature 240, with corresponding thalweg 242, and a third feature 250, with corresponding thalweg 252, are depicted within volume 200. As noted above, the method of the present invention may be applied to the regions affected by each of these features sequentially, but independent of each other and independent of the calculations corresponding to feature 210. This aspect of the present method facilitates modeling of features having different azimuthal characteristics, and thereby having different directions for which continuity modeling is desired to be carried out. Note that feature 240 is depicted as having constant boundaries with depth, and therefore is an example of a feature which could be modeled in a single layer of blocks that extend in the direction of the Y-axis, in other words a two-dimensional array of blocks.

FIG. 3 depicts a flow chart corresponding to a first embodiment of the present invention. Initially, the spatial coordinate system corresponding to the subsurface portion of the earth of interest is determined, FIG. 3, step 300. As noted above in reference to FIG. 2, this involves the specification of the XYZ space corresponding to the subsurface volume of interest.

The next two steps involve the specification of information related to the feature for which continuity is to be controlled according to the present invention. In FIG. 3, step 302, the data that is to be used to control the continuity of the feature is specified. This data may include, for example but without limitation, well data or seismic data. The data that is to be used in the geologic modeling will also be specified. In FIG. 3, step 304, the portion of the spatial coordinate system within which the feature of interest lies is specified. This is the portion of XYZ space for which the rock property of interest is to be interpreted in a manner in which continuity is controlled. For example, in FIG. 2, three regions of volume 200 contain features for which continuity is to be modeled. These three regions correspond to features 210, 240, and 250. The method of the present invention is applied to each of these features independent of the application of the method to each other feature in the specified XYZ space.

Next, FIG. 3, step 306, the thalweg is specified for the portion of the XYZ space which was specified in step 304. For feature 210 in FIG. 2, thalweg 212 is specified.

In FIG. 3, step 308, a new coordinate system is determined. This new coordinate system will be referred to as the transformed coordinate system, and will generally be of the same dimension as the dimension of the original spatial coordinate system, either two-dimensional or three dimensional. As noted, the transformations of the present method may be applied to individual layers of the subsurface volume, in which case the transformation will be two-dimensional, from the XY space corresponding to the layer to a transformed coordinate system which will be referred to as X*Y* space. This ability to apply the present method to two-dimensional analysis derives from the characteristic that the thalweg of a feature generally does not vary vertically as the feature meanders through the XYZ space of the subsurface model if the coordinate system involves a relative Z space. This is an advantage of the present method, because analysts often prefer to avoid the complexities of three-dimensional analysis. If the method is applied in a three-dimensional application, the transformed coordinate system will be referred to as X*Y*Z* space. Hereafter, references will be made, without limitation, to X*Y* space. In either case, the transformed coordinate system will be specified in such a manner that the thalweg defined in FIG. 3, step 306, is substantially linear in the transformed coordinate system. In other words, the thalweg after the transformation is represented by a substantially straight line. The determination of the transformed coordinate system which accomplishes this transformation from a nonlinear to a substantially linear thalweg effectively involves the specification of a mapping algorithm from the original coordinate system (in other words, XY space) to the transformed coordinate system (X*Y* space). It is preferable that the transformation result in as linear a transformed thalweg as possible, so that the azimuthally controlled model will be as accurate as possible. However, application of the present method to transformed thalwegs which retain some amount of nonlinearity will nevertheless result in improved continuity controlled models.

In FIG. 3, step 310, the mapping specified in step 308 is applied to the information specified in steps 302 and 304. In particular, the information from step 302 is mapped from XY space to X*Y* space. In addition, the portion of the model encompassing the feature, as specified in step 304, is mapped to X*Y* space. This transformation to X*Y* space will generally result in the feature having different characteristics, such as width and length, in X*Y* space than it was characterized by in XY space and having a substantially linear thalweg.

In FIG. 3, step 312, modeling is carried out in the transformed coordinate system. This modeling may involve any of the geologic modeling methods known to practitioners of the art, for example geostatistical or spectral, and will generally be carried out in three dimensions. This modeling will be performed with the direction of maximum continuity set as a constant azimuth aligned with the transformed thalweg in the transformation coordinate system. The information used in the selected method—for example variograms, passband spectra, or other controls—should have been transformed to the transformation coordinate system in step 310. The model which results from the modeling of step 312 is referred to as the transformed model (or, in the two-dimensional case, as the X*Y* model).

Finally, the transformed model is inverse transformed to the original coordinate system (for example, from X*Y* space to XY space) to generate a geologic model with the feature of interest having controlled continuity. The inverse transformation can be layer-by-layer, or may be three dimensional, for the reasons noted above in association with the transformation to the transformed coordinate system.

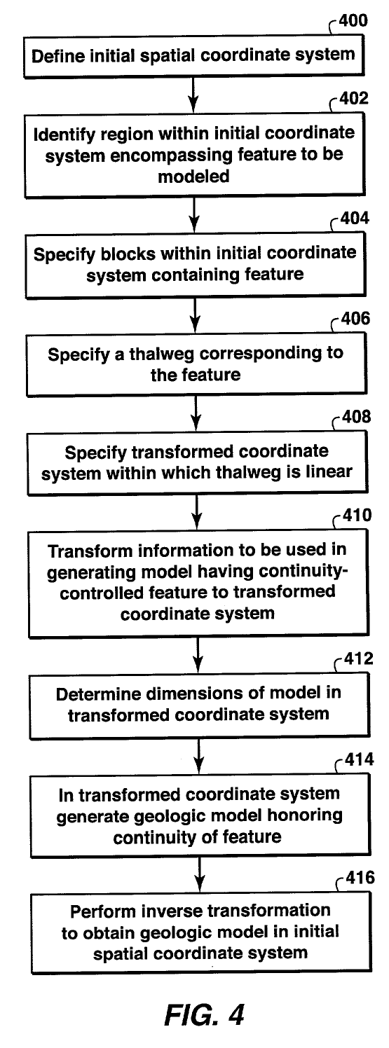

A preferred embodiment of the present invention is depicted in FIG. 4, and discussed further in the following paragraphs. Initially, FIG. 4, step 400, an initial spatial coordinate system that defines the limits of the subsurface region of interest is specified. An array of blocks that comprise the complete subsurface region are also specified. These blocks will not overlap. In this step of the present embodiment, each block is assigned a position and a volume in the subsurface, but will not yet have been assigned rock properties.

In FIG. 4, step 402, the portion of the subsurface region specified in step 400 which contains the feature to be modeled is specified. Example features include a channel complex, seismic facies, environments of deposition, and the like. This specification will generally derive from interpretation of seismic surveys, but may, in the alternative or in combination with seismic data, also be based on geological or other interpretational information.

Next, FIG. 4, step 404, the blocks in the initial coordinate system that encompass the feature specified in step 402 are identified. A feature may extend vertically through the entire thickness of a subsurface reservoir or zone, or may fall within a specified group of blocks within the model. Generally, the blocks will be identified by a listing or other tabulation of all blocks affected by the feature. The blocks do not need to be contiguous if the rock properties in all blocks have substantially the same spectral and other characteristics and if a single thalweg can accurately represent the overall continuity of the feature of interest. The blocks corresponding to a thalweg may not be contiguous, for example, in subsurface volumes having two or more features which intersect each other. The geologically later-occurring of such features will often have eroded through the earlier-occurring feature in such a manner that a thalweg may correctly represent the centerline of the earlier feature even though the blocks corresponding to the eroded portion no longer represent geologic information from the earlier feature.

In FIG. 4, step 406, a thalweg that describes the spatial variation of continuity for the feature of interest is defined. The thalweg is a key element in the azimuth-consistent modeling process and will generally consist of connected line segments defined by XY coordinates. The thalweg begins at a first end of the feature and extends to a second end of the feature.

The thalweg may be generated by a computer program, for example by analyzing the shape and orientation of the feature to be modeled. However, more commonly the thalweg will be interpreted and defined manually. Preferably, the thalweg will represent a simple, smoothly varying form. Simply defined thalwegs can be easily defined using the line-digitizing capability of various software programs that will be known to those skilled in the art. Alternatively, the thalweg can be drawn on a map of the region encompassing the feature of interest, and the points digitized into XY coordinates either manually or with an electronic digitizer.

In FIG. 4, step 408, a transformation is defined which will transform the thalweg from the XY space of the original model into a new X*Y* space in which the transformed thalweg is effectively a straight line. Any of several transformation processes that will be known to those skilled in the art may be used. One convenient transformation option would be to define the Y* coordinate as the distance along the thalweg, in other words following along and tracing the bends in the thalweg. In this option, the X* coordinate would be defined as the lateral offset distance, in other words, perpendicular from the thalweg to various points within the feature for which continuity is to be controlled. In this option, for convenience the Y* coordinate might arbitrarily be defined so that the thalweg, and hence the feature, begins at a first end of X*Y* space, perhaps at origin Y*=0, and extends towards a second end, for example from the origin along increasingly more positive values of Y*.

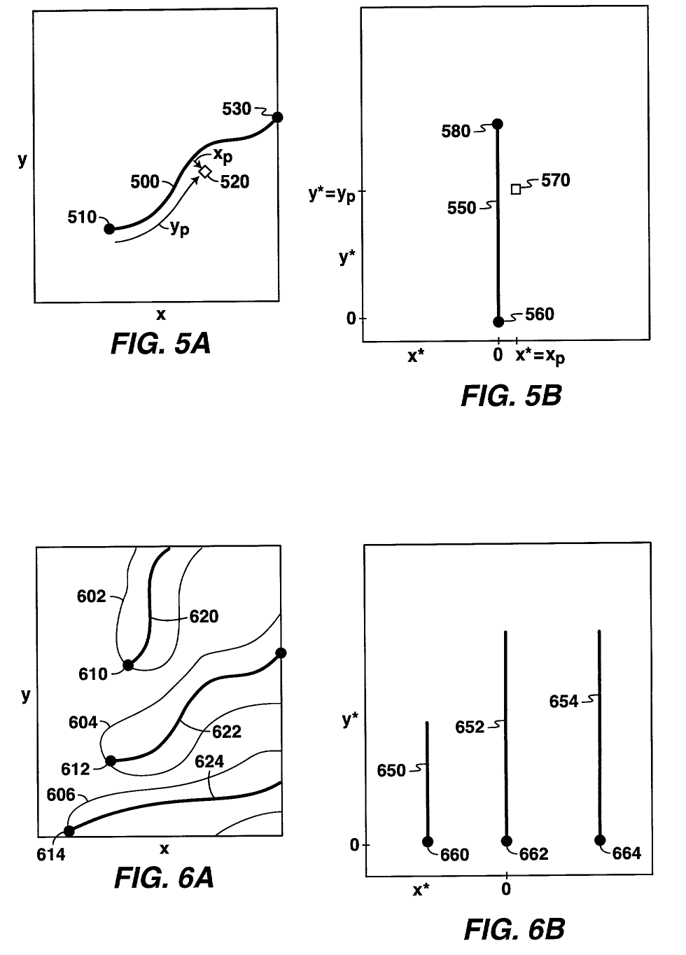

FIG. 5 depicts an example of this transformation option. Thalweg 500 in FIG. 5A begins at point 510. Thalweg 500 is transformed into a straight line, a transformed-thalweg 550, in FIG. 5B, which extends toward larger values of Y*, but along the constant value X*=0. Point 510 in FIG. 5A is transformed into point 560 in FIG. 5B. The specification of the X* coordinate of the transformed thalweg 550 at origin X*=0 is for convenience and is not limiting. As further discussed below, points not lying on the transformed-thalweg 550 will have negative X* values to the left and positive X* values to the right. Preferably, the direction along which maximum continuity is expected, in other words the direction of greatest range of variogram values, will be oriented in X*Y* space in a single convenient direction such as from south-to-north, so as to simplify the transformation and modeling processes. Interchanging X* and Y*, or altering the origin point from that shown in FIG. 5B, is within the scope of this method.

In the present embodiment, only the data to be used in the continuity-controlling and modeling process, such as from wells and seismic or other data, are transformed to X*Y* space, FIG. 4, step 410.

Step 410 is performed following a process of applying the previously specified transformation to points of interest in XY space. For the example depicted in FIG. 5, the transformation for any point of interest in XY space is simply to determine the perpendicular distance from the point to thalweg 500. In the example of FIG. 5, this perpendicular distance thereby defines the value X*, and the distance along the thalweg to the intersection of that perpendicular on thalweg 500 is Y*. For example, point 520 in XY space lies a distance Xₚ from thalweg 500, and the distance along thalweg 500 from the perpendicular intersecting the location of point 520 is Yₚ. Point 520 is therefore transformed into point 570, which lies at coordinates (Xₚ,Yₚ) in X*Y* space.

In FIG. 4, step 412, the dimensions of the model to be constructed in X*Y* space are specified. This is a preliminary step to the carrying out of the geologic modeling in X*Y* space. Note that because most features of interest, and therefore most thalwegs, will curve in XY space, the transformed-thalweg in X*Y* space will result in a Y* dimension of the model in X*Y* space longer than the analogous model would have in XY space. For example, the distance along the thalweg 500 in FIG. 5 from point 510 to point 530 is greater than any straight-line dimension of feature 500. Similarly, the range of X* is less than the range of X for the feature in XY space. Preferably, the top and base of the model in X*Y* space will be defined by two horizontal, planar surfaces, separated by a thickness at least as great as the thickest part of the region being modeled. This will generally be possible if a relative Z coordinate is used. The Z* coordinate will preferably be a relative coordinate if a relative coordinate was used in XYZ space. The lateral dimensions of the blocks in both XY and X*Y* space should be identical, thereby allowing the blocks in each space to have a one-to-one correspondence. Similarly, the blocks should preferably correspond vertically between the two spaces. Preferably, blocks should not vary in thickness laterally over different parts of the XY space, and therefore blocks should not be defined with a proportional stratigraphy. Finally, the X*Y* space is preferably assumed to have constant-thickness cells relative to the top or base. These preferences facilitate tracking of variability in the geologic modeling process, but are not limitations of the method.

At the conclusion of FIG. 4, step 412, all data related to the feature of interest, and the portion of the XY space containing that feature will have been transformed into X*Y* space in a manner in which the thalweg is a substantially straight line. In FIG. 4, step 414, a geologic modeling process is carried out. This step will be understood to those skilled in the art. For example, a spectral-simulation model in X*Y* space may be built using any of several spectral-simulation methods. In a preferred embodiment, the method of Calvert et al. may be used. This modeling will be based on the well data, seismic data, and other information which was transformed to X*Y* space in step 410. In the process of generating a model in X*Y* space, all spectra, variograms, and other information will be in X*Y* space.

The process of this invention may also be applied to non-spectral-simulation modeling. The use in step 414 of any type of modeling method (for example geostatistical) will generate a model with azimuthal control.

After completion of the modeling process of step 414, the geologic model is inverse transformed from X*Y* space back to XY space, FIG. 4, step 416. In this inverse transform, the data in the X*Y* space model is mapped into XY space. The result is that the petrophysical values which characterize the geologic model in the X*Y* space are mapped into a geologic model in XY space. The inverse mapping required by step 416 involves the reverse of the process carried out in step 410, and described in association with FIG. 5.

As noted above in association with paragraph 30 and FIG. 2, features of interest in geologic modeling often involve one or more vertically-stacked blocks. This characteristic simplifies the application of the transformation in the present invention. Specifically, when the correspondence between the X*Y* model and the XY model has been determined for a block in a first layer of the feature of interest, the transformation relationship can be applied directly to the blocks in other layers which lie directly below that block. Thus, in the inverse transform from X*Y* to XY, for example, the inverse transform calculations only need to be computed one time. Furthermore, the inverse transformations may also be replaced by the use of a look-up table deriving from the forward transformation. Specifically, the table would comprise the mapping coordinates calculated for the forward transformations, and merely be used in reverse when inverse transforming the modeled results back to the original coordinate system.

Numerous variations on the method of the present invention will be apparent to those skilled in the art. In one embodiment, the lateral block dimensions in the X*Y* space may differ from the dimensions in XY space. In another embodiment, all blocks in the XY model may not all be the same size, and therefore the blocks in the X*Y* model would not all be the same size. In any such embodiments a simple computation relating the blocks in one model to the blocks in the other model will be involved, as will be apparent to those skilled in the art.

It will also be noted that the centerline, and therefore the thalweg, of a feature may not necessarily be the same in each layer of the subsurface volume that encompasses a feature of interest. In such case a separate thalweg may be specified for each layer, and embodiments of the present method will be apparent in which the coordinate transformation is performed on a layer-by-layer basis, thus allowing each layer to be continuity-controlled according to the present method.

In another embodiment of the invention, the vertical block dimensions may vary. For example, thicknesses of blocks may be defined as proportional to reservoir thickness, and such thicknesses may then vary spatially as the reservoir being modeled varies in thickness. As a result, the same number of blocks may not be found at a location in X*Y* space as in the corresponding location in XY space. This characteristic may be implemented in proportional vertical coordinates in both the XY and the X*Y* space by assuming that the same proportions of reservoir thickness must match in X*Y* space and XY space. As an example, a block 40% from the top of the reservoir in XY space would be assumed to be 40% from the top in X*Y* space. This is another example of the use of relative Z coordinates in the present method.

The foregoing description of the present method involved a modeling embodiment in which one rock property was being modeled. In another embodiment, two or more petrophysical properties may be modeled, for example by defining two or more spectral-simulations in X*Y* space. Each such simulation in X*Y* space would relate to the same X*Y* coordinate blocks, but would relate to different petrophysical properties. The process of transferring values from the two or more X*Y* models to the XY model only needs to involve one inversion from X*Y* to XY space for each block. That inversion can then be used for the corresponding block in each of the X*Y* models to transform each of the different modeled petrophysical properties to XY space.

In yet another embodiment of the present invention, the method can be applied to model subsurface volumes in which more than one feature is to be modeled. In this embodiment, each of the features would have a corresponding thalweg, and the several resulting geologic models would then be merged to derive a single geologic model that contains the petrophysical properties from all features. If the modeling controls (for example variograms or spectra) are the same for each feature, then another embodiment of this invention allows the simultaneous modeling of each such feature with one X*Y* model. In this embodiment, the blocks specified for modeling each feature must have a unique identifier so that the correct thalweg may be related to different portions of the X*Y* model and the XY model. In this case, an X*Y* model is generated that is large enough in the X* and Y* directions to contain all of the features at once. The thalweg for each feature would begin at a different point in the X*Y* model, and all thalwegs would extend in the same direction. For example, FIG. 6A shows an XY space with three features, 602, 604, and 606, with corresponding thalwegs 620, 622, and 624, and corresponding thalweg starting points 610, 612, and 614. FIG. 6B shows the X*Y* space representation in which the corresponding three linear thalwegs 650, 652, and 654 have starting points 660, 662, and 664. Well coordinates would have to be transformed to match the coordinates assigned to the appropriate thalweg. The feature identifiers would allow selection of the appropriate thalweg for a given feature when transferring from the X*Y* model.

As noted above, the discussion of the present invention related to two dimensions. The present method may be applied to three dimensions, with a thalweg defined in XYZ space. In such an application, the direction of maximum continuity of the property of interest would then be allowed to move up or down stratigraphically, as well as laterally. The coordinate-system transform would then be from XYZ space to X*Y*Z* space, with X* and Y* defined as in the preferred embodiment and Z* relating, for example, to a function of depth below the top of the reservoir. Both the forward and the inverse transform would have to take into account all three dimensions in any such embodiment.

The description of a preferred embodiment specifies a transformation of the coordinate system that has been found to be effective for the purpose of this invention. Other embodiments may use variations of this transform, as well as other transforms, which result in a substantially linear thalweg in a second coordinate system. As will be understood to those skilled in the art, the transforms used in embodiments of the present method will generally be non-linear and may result in distortions of the characteristics of the feature or features of interest, and that this consideration should be taken into account when selecting the transform to be used prior to carrying out the modeling step of the present method.

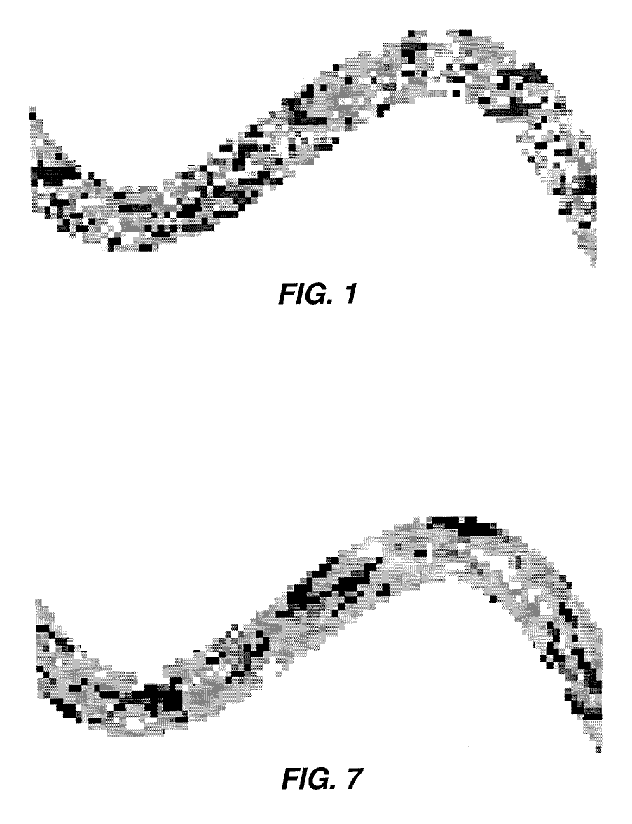

The improved modeling capabilities of the present invention are demonstrated by comparing the results of a prior constant west-to-east orientation of continuity model, as depicted in FIG. 1, with the results in FIG. 7, which derive from the embodiment of the present invention depicted in FIG. 3. As can be observed, the river system feature is now characterized by a distribution of porosity which correlates well with the channel's local orientation.

It should be understood that the preceding is merely a detailed description of specific embodiments of this invention. Other embodiments may be employed and numerous changes to the disclosed embodiments may be made in accordance with the disclosure herein without departing from the spirit or scope of the present invention. Furthermore, each of the above embodiments is within the scope of the present invention. The preceding description, therefore, is not meant to limit the scope of the invention. Rather, the scope of the invention is to be determined only by the appended claims and their equivalents.

What is claimed is:

1. A subsurface modeling method comprising:
(a) defining a first coordinate system for a volume of the earth for which a model is desired;
(b) selecting at least one feature within said volume;
(c) specifying a reference line corresponding to said feature;
(d) transforming said feature into a second coordinate system in which said reference line is substantially linear;
(e) transforming modeling data corresponding to said feature into said second coordinate system;
(f) using said transformed modeling data and a spectral modeling method to generate a continuity-controlled subsurface model of said feature in said second coordinate system; and
(g) inverse transforming said subsurface model into said first coordinate system.

2. The method of claim 1 wherein a depth coordinate in said first coordinate system represents a depth relative to the surface of the earth.

3. The method of claim 1 wherein a depth coordinate in said first coordinate system represents a depth relative to at least one geologic surface.

4. The method of claim 1 wherein a depth coordinate in said first coordinate system represents seismic time.

5. The method of claim 1 wherein said reference line is a centerline of said feature.

6. The method of claim I wherein said reference line is a thalweg associated with said feature.

7. The method of claim 1 wherein said feature encompasses one layer in depth within said first coordinate system.

8. The method of claim 1 wherein said feature encompasses at least two layers in depth within said first coordinate system.

9. The method of claim 8 wherein said reference line corresponding to said feature corresponds to each of said at least two layers in depth.

10. The method of claim 8 wherein at least two reference lines are specified for said feature, each said reference line corresponding to at least one said layer.

11. The method of claim 10 wherein said transform into said second coordinate system linearizes each of said at least two reference lines.

12. The method of claim 10 wherein a separate transform into said second coordinate system is required for each of said at least two separate reference lines, and wherein a separate model is generated in said second coordinate system for each of said at least two separate reference lines.

13. The method of claim 12 wherein an inverse transform into said first coordinate system is performed for each of said models.

14. The method of claim 1 wherein said transform into said second coordinate system involves the specification of a first axis which represents a distance along said reference line and a second axis which represents an orthogonal distance from said reference line.

15. The method of claim 1 wherein said modeling data are selected from a group comprising porosity, net-gross ratio, permeability, shale volume, net sand percent, net pore volume, hydrocarbon saturation, hydrocarbon pore volume, capillary pressure, acoustic impedance, seismic velocity, and lithology.

16. The method of claim 1 wherein said volume is subdivided into an array of three-dimensional blocks for which said geologic model is desired.

17. The method of claim 16 wherein the dimensions of said three-dimensional blocks vary between layers and said continuity-controlled geologic modeling method is applied on a layer-by-layer basis.

18. The method of claim 1 wherein the transform of said feature into said second coordinate system involves the transform of the boundaries of said feature in said first coordinate system into said second coordinate system.

19. The method of claim 1 wherein at least two features are specified within said volume, each said feature having a corresponding reference line, each of said reference lines being substantially linear in said second coordinate system.

20. The method of claim 19 wherein a single transform is required to linearize all said reference lines in said second coordinate system.

21. The method of claim 19 wherein a separate transform into a corresponding said second coordinate system is required for each of said at least two reference lines, and wherein a separate continuity-controlled geologic model is generated in each said second coordinate system.

22. The method of claim 21 wherein an inverse transform into said first coordinate system is performed for each of said models.

23. The method of claim 1 wherein said spectral modeling method involves spectral-simulation modeling.

24. The method of claim 1 wherein at least two modeling parameters are to be continuity-controlled for said feature, the models for each of said parameters generated independently of the models for each of said other parameters.

25. The method of claim 1 wherein said reference line is three-dimensional.

26. The method of claim 1 wherein said transform and said inverse transform are three-dimensional.

27. The method of claim 1 wherein said feature is not substantially contiguous within said volume.

28. A subsurface modeling method comprising:
(a) defining a first coordinate system for a volume of the earth for which a model is desired;
(b) selecting at least one feature within said volume;
(c) specifying a thalweg corresponding to said feature;
(d) transforming each of one or more layers corresponding to said feature into a second coordinate system in which said thalweg is substantially linear;
(e) transforming modeling data corresponding to said feature into said second coordinate system;
(f) using said transformed modeling data and a three-dimensional spectral modeling method to generate a continuity-controlled subsurface model of said feature in said second coordinate system; and
(g) inverse transforming said subsurface model into said first coordinate system.

29. A subsurface modeling method comprising:
(a) defining a first coordinate system for a volume of the earth for which a model is desired;
(b) selecting at least one feature within said volume;
(c) specifying a thalweg corresponding to said feature;
(d) transforming each of one or more layers corresponding to said feature into a second coordinate system in which said thalweg is substantially linear, wherein said transform into said second coordinate system involves the specification of a first axis which represents a distance along said thalweg and a second axis which represents an orthogonal distance from said thalweg;
(e) transforming modeling data corresponding to said feature into said second coordinate system;
(f) using said transformed modeling data and a three-dimensional spectral modeling method to generate a continuity-controlled subsurface model of said feature in said second coordinate system; and
(g) inverse transforming said subsurface model into said first coordinate system.
